(19) United States
(12) Patent Application Publication
(10) Pub. No.: US 2014/0049939 A1
(43) Pub. Date: Feb. 20, 2014

(54) LAMP WITH INTEGRAL SPEAKER SYSTEM FOR AUDIO

(71) Applicant: GE Lighting Solutions, LLC, East Cleveland, OH (US)

(72) Inventors: Glenn Howard KUENZLER, East Cleveland, OH (US); Brian Magann RUSH, Niskayuna, NY (US); Stanton Earl WEAVER, Niskayuna, NY (US)

(73) Assignee: GE Lighting Solutions, LLC, East Cleveland, OH (US)

(21) Appl. No.: 13/966,379

(22) Filed: Aug. 14, 2013

Related U.S. Application Data
(60) Provisional application No. 61/684,914, filed on Aug. 20, 2012.

(51) Int. Cl. F21V 33/00; F21S 8/04; F21K 99/00

(52) U.S. Cl. CPC F21V 33/0056; F21K 9/56; F21S 8/04
USPC 362/84; 362/311.02; 362/307

(57) ABSTRACT

Provided is a light emitting diode (LED) lighting system. The system includes one or more LEDs and a transparent membrane positioned in cooperative arrangement with the LEDs. The transparent membrane is configured to control light produced by the LEDs and produce sound old.

### CROSS-REFERENCE TO OTHER APPLICATIONS

This application claims priority of U.S. Provisional Patent Application No. 61/684,914, entitled “Lamp with Integral Speaker System for Audio,” filed Aug. 20, 2012, which is herein incorporated in its entirety by reference.

### I. FIELD OF THE INVENTION

The present invention relates generally to light emitting diode (LED) lighting. More particularly, the present invention relates to providing cost-effective cooling and audio transmission capabilities for an LED lighting system.

### II. BACKGROUND OF THE INVENTION

LED lamps are now widely accepted as a more efficient and environmental friendly light source than other lighting sources, such as fluorescent lamps. LED lamps allow electrical current to pass through the device in one direction while blocking current flow in the opposite direction. LED lamps provide many advantages as a lighting alternative compared to fluorescent lamps. Some benefits of using LED lamps include no mercury, operation in extreme cold conditions, longer life, and better energy efficiency.

Although LEDs are particularly efficient when compared, for example, with incandescent light bulbs or compact fluorescent lamps (CFLs), LEDs can generate a significant amount of heat. This heat generation can severely impact LED reliability. Generally, LED reliability can be increased when the junction temperature of its semiconductor structure can be held less than 100° C. By increasing LED reliability, overall lighting system lifecycle costs can be reduced since LEDs represent about 50 to 60% of the total system cost.

Another important consideration concerning LEDs is their ability to be overdriven. For example, if an LED is driven at a level of 200% of its rated current level, it correspondingly generates about a little less than 200% of its rated light output. The light output is generally nonlinear with increasing current and the LED becomes less efficient. Overdriving, however, contributes to heat generation and in turn creates the need for cooling systems that go beyond conventional passive cooling. U.S. Pub. No. 2012/0051058 A1, which is herein incorporated in its entirety by reference, describes one approach for actively cooling LEDs without impeding their optical performance.

The active cooling approach noted above is discussed in greater detail below. In short, this approach uses piezo actuators (i.e., transducers) positioned on opposing sides of a lens, or other optical component, formed of a transparent sheet or membrane. When activated, the actuators cause the lens to bow and deflect. This bowing and deflecting movement draws air into a cavity formed around the LEDs, and moves the air across the LEDs to provide cooling. As, also discussed below, this lens movement can be used to control the angle distribution of the flow of light from the LEDs. Use of transducers to create mechanical motion in a transparent sheet also has other purposes.

For example, piezo-based transducers have been used to create mechanical motion in transparent sheets to act as a transparent acoustic device, such as a speaker. U.S. Pat. No. 8,189,851, which is herein incorporated in its entirety by reference, describes such a process. This process is also described in greater detail below.

In many commercial applications, ceiling-based lighting systems and audio systems separately consume a significant amount of ceiling space. Additionally, each of these systems typically requires its own separate electrical system and resources which can be unsightly and cumbersome due to holes cut in the ceiling, as well as other measures, to accommodate the separate audio and lighting systems.

### III. SUMMARY OF THE EMBODIMENTS OF THE INVENTION

Given the aforementioned deficiencies, a need exists for high-end aesthetically attractive ceiling installations that can combine both sound and light production without requiring separate installations. Particularly, the need exists for a combined audio/lighting system that avoids the need for separate wiring and separate ceiling mounts.

One embodiment of the present invention provides an LED lighting system. The system includes one or more LEDs and a transparent membrane positioned in cooperative arrangement with the LEDs. The transparent membrane is configured to control light produced by the LEDs and produce sound.

Embodiments of the present invention combine transparent speaker technology with lighting technology to provide both light and sound in a single package. One exemplary application of embodiments of the present invention would be for an illumination LED product that suspends from the ceiling. In the embodiments, a transparent membrane speaker can be placed over the light source such that it produces great sound without being noticeably present. For audio/video conference room applications, such transparent speakers may additionally act as high quality microphones. Additional embodiments of the present invention, for example, can implement aspects of the lighting and/or audio system in a wireless manner.

In yet another embodiment, a speaker is constructed of a transparent material or membrane (e.g., plastic) suspended in its middle. Sound is generated by pushing on the edges of the membrane to make it deflect forward and backwards. The system further includes a light panel, for example, an LED panel that can be mounted in a ceiling. The light panel can be any number of sizes and is typically square or rectangular in shape.

The light panel has a frame with LEDs mounted therein, with the LEDs pointing inwardly. The light panel also includes a diffusing panel (or light guide or waveguide), which causes the light to glow evenly. Light is thereby produced across the surface of the panel. The light panel and the transparent speaker may be sized approximately equivalently, so the speaker and the light panel cannot be easily distinguished from one another. The sound signal transmission technology may be wireless.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an exemplary sectional side view of a directional lamp having a plurality of LED devices on a circuit board constructed in accordance with an embodiment of the present invention.

FIG. 2 is an exemplary illustration of a conventional transparent layer configurable for producing sound in accordance with the embodiments.

FIG. 3 is an illustration of an exemplary lighting and audio system constructed in accordance with the embodiments.

FIG. 4 is an illustration of aspects of the lighting and audio system illustrated in FIG. 3 fully assembled.

FIG. 5 is an illustration of an exemplary lighting system constructed in accordance with a second embodiment of the present invention.

FIG. 6 is an illustration of an exemplary lighting system constructed in accordance with a third embodiment of the present invention.

### V. DETAILED DESCRIPTION OF VARIOUS EMBODIMENTS

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The following detailed description is merely exemplary in nature and is not intended to limit the applications and uses disclosed herein. Further, there is no intention to be bound by any theory presented in the preceding background or summary or the following detailed description.

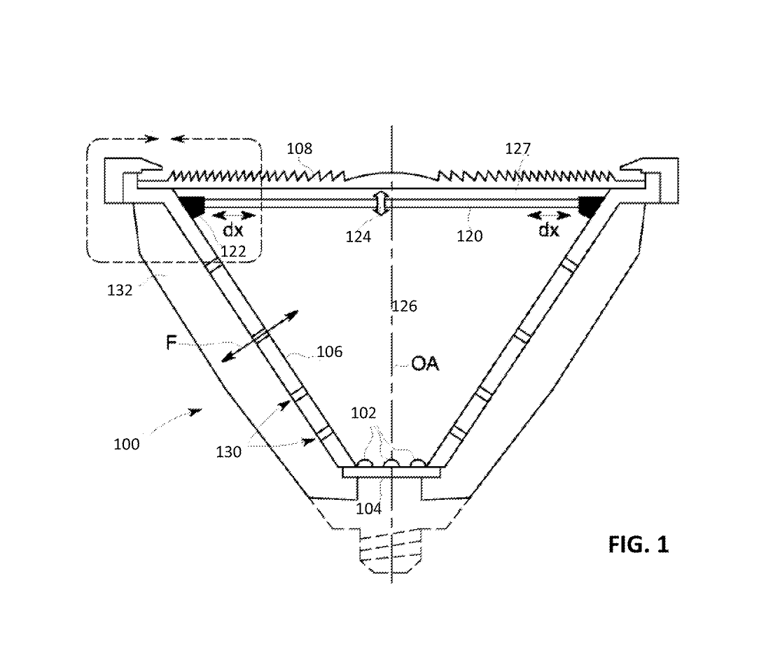

With reference to FIG. 1, and by way of background, a sectional side view of a conventional directional lamp 100 having rotational symmetry about an optical axis OA is shown. The lamp includes a plurality of light emitting diode (LED) devices 102 on a circuit board 104, a collecting reflector 106 which in the illustrative embodiment is conical (although other shapes are contemplated, such as parabolic or compound parabolic). The lamp also includes a Fresnel lens 108.

More generally, the LED devices 102 can be replaced by one or more other solid state lighting devices, such as one or more organic LED (OLED) devices, one or more electroluminescent (EL) devices, or so forth. In a typical configuration, the light engine 102, 104 is arranged at about the focal length of the Fresnel lens 108 so that the lens 108 images the light engine at infinity so as to form a directional beam. The collecting reflector 106 collects large angle light, and may also optionally provide collimation to assist in forming the beam. In some embodiments, the lens 108 is omitted and the reflector 106 alone is relied upon to form the directional light beam. In another alternative, the lens may be located elsewhere than where shown in FIG. 1, such as proximate to the LED devices 102.

An optical membrane 120 is disposed in the beam path. The optical membrane 120 is optically transparent or translucent. In some embodiments, the optical membrane is a transparent or translucent optical window. In some embodiments, the optical membrane 120 acts optically as a light diffuser by including diffusing particles or making the membrane 120 of a light scattering material, or by providing the membrane 120 with a roughened or otherwise light scattering or light refracting surface, or so forth.

It is also additionally or alternatively contemplated for the optical membrane 120 to be a wavelength converting element including, for example, at least one phosphor compound, or a quantum dot wavelength converter, or so forth. The optical membrane 120 may additionally or alternatively provide other optical functionality, such as providing an anti-reflection coating, wavelength selective filtering to remove ultraviolet light or other light that may be undesirable in the directional light beam, or so forth.

The optical membrane 120 also serves a secondary purpose (besides being an optical window or other optical element)—the optical membrane 120 serves as an active cooling element. Toward this end, at least one electromechanical transducer 122 is configured to generate a force or small reciprocating linear displacement dx causing a pulsating mechanical deformation of the optical membrane 120.

The electromechanical transducer(s) can comprise a plurality of transducers at the periphery of the optical membrane 120 and spaced at angular intervals around the optical axis OA, or a single annular transducer may be disposed at the membrane periphery. In the illustrative embodiment, the transducer 122 generates the reciprocating linear displacement dx in the plane of the membrane 120 with all displacements being in phase (e.g., all displacing “inward” at the same instant) so as to cause the optical membrane 120 to undergo an “up/down” motion indicated by an up/down arrow 124. In some embodiments, the pulsating mechanical deformation of the membrane 120 takes the form of excitation of a resonant standing wave drum membrane mode in the optical membrane 120.

Additionally or alternatively, the pulsating mechanical deformation may include various patterns, and may or may not be resonant. Still further, it is contemplated for the transducer(s) 122 to generate displacements in a direction transverse to the membrane, or in a direction intermediate between in plane and transverse respective to the membrane, or to produce some other complex motion leading to a pulsating mechanical deformation of the membrane.

The pulsating mechanical deformation produces a volume displacement of air with a frequency or other time variation corresponding to the pulsating. This provides air movement that actively cools the at least one solid state lighting device (e.g., the illustrative LED devices 102). The active cooling of the solid state lighting device may operate directly on the solid state lighting device, or indirectly by actively cooling a heat sink in thermal communication with the solid state lighting device.

In some embodiments, the optical membrane 120 forms at least one wall of an enclosure. In the illustrative example, the optical membrane 120 and the collecting reflector 106 cooperatively form an enclosure enclosing a volume 126, which is typically filled with air (although filling with another fluid is also contemplated). The volume displacement of air provided by the pulsating mechanical deformation of the optical membrane 120 produces movement in the constricted space 126.

In the illustrative example of FIG. 1, it will be noted that a second, smaller air space 127 is located between the Fresnel lens 108 and the optical membrane 120. This smaller air space is optionally vented to the exterior, for example via holes in or at the periphery of the lens 108, so that the air space 127 does not create thermal resistance to the pulsating mechanical deformation of the membrane 120.

In some embodiments, the enclosure defined in part by the membrane 120 is further provided with one or more openings 130 which allow air flow (diagrammatically indicated for one opening in FIG. 1 by a double arrow F, but understood to occur at all the openings 130) into or out of the enclosed volume 126. In some such embodiments, the openings 130 and the membrane 120 cooperate to define synthetic jets at the openings 130.

The volume displacement of air provided by the pulsating mechanical deformation of the optical membrane 120 and a size of the at least one opening 130 are selected such that the volume displacement of air provided by the pulsating mechanical deformation of the optical membrane 120 produces at least one synthetic jet. The synthetic jet or jets are arranged to enhance air cooling of the at least one solid state lighting device (e.g., the illustrative LED devices 102).

In FIG. 1, the synthetic jets enhance air cooling of the LED devices 102 indirectly, by arranging the openings 130 to produce air flow or air turbulence proximate to heat fins 132 spaced apart around the collecting reflector 106. Without loss of generality, there are N heat fins spaced apart around the collecting reflector 16 at angular intervals of 360° /N. Note that in this case the rotational symmetry of the directional lamp 100 is an N fold rotational symmetry. The heat fins 132 are in thermal communication with the LED devices 102 via the circuit board 104 (which optionally includes a metal core in thermal communication with the heat sinking fins 132). FIG. 1 is discussed in greater detail in U.S. Pub. No. 2012/0051058 A1, which is herein incorporated in its entirety by reference.

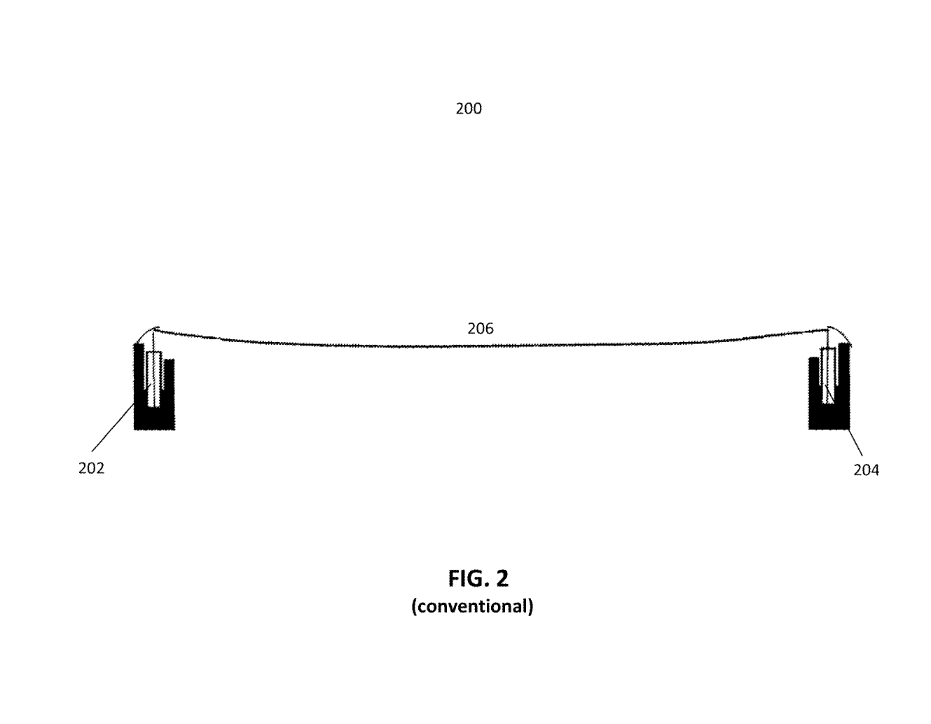

FIG. 2 is an exemplary illustration of a conventional transparent layer configurable for producing sound in accordance with the embodiments. More specifically, FIG. 2 is an illustration of a device 200 including mechanical to acoustical transducers 202 and 204, which can be formed from piezoelectric actuators. The transducers 202 and 204 are a coupled to the end of a transparent membrane 206, such as an acrylic layer, that can serve as a lens or acoustic diaphragm. As noted above, details of using the device 200 as an acoustic diaphragm are described in U.S. Pat. No. 8,189,851, entitled Optically clear diaphragm for an acoustic transducer and method for making same.

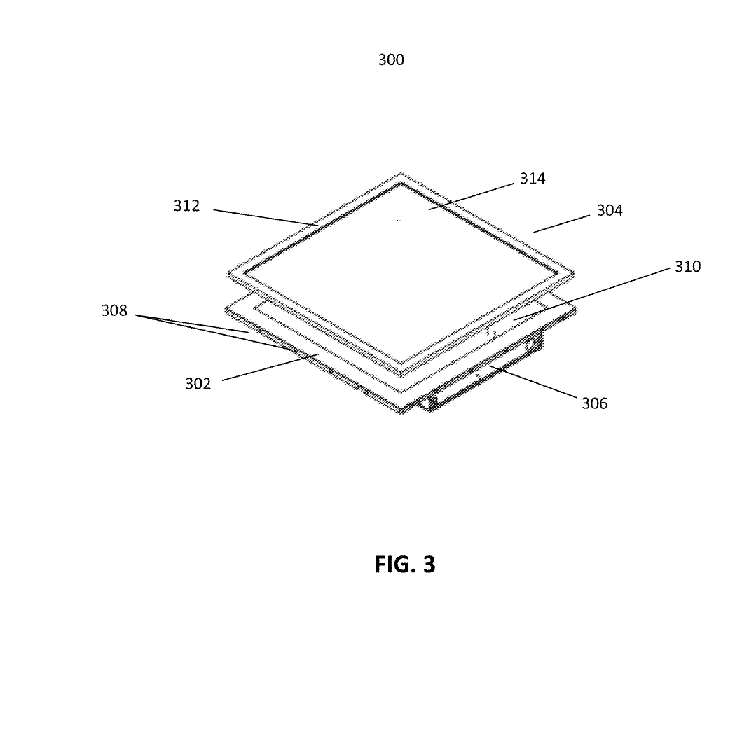

FIG. 3 is an illustration of an exemplary audio/lighting system 300 constructed in accordance with the embodiments. The audio/lighting system 300 is ideally suited, but not limited to, for use in ceilings in place of fluorescent lamps. By way of example only, and not limitation, the audio/lighting system 300, depicted in FIG. 3, is a 2×2 design. However, many other styles are available.

The audio/lighting system 300 includes a light panel 302, a transparent speaker 304, and an LED driver 306. The light panel 302 includes LEDs 308 positioned around a perimeter of the light panel 302. The LEDs 308 are pointed inward toward the edge of a light diffusing membrane 310, which serves as an LED diffuser. The net effect is that the diffusing membrane 310 is uniformly illuminated.

The diffusing membrane 310 includes lens slit patterns on its surface for injection of white light from the LEDs 308. The lens slit pattern serves as a waveguide for reflecting light produced by the LEDs 308 across the surface of the light panel 302. The LED driver 306 is merely a module that contains electronics to convert an alternating current (AC) received from a power source to a direct current (DC), constant current source needed by the LEDs 308s for power.

The transparent speaker 304 includes a frame 312 and its own transparent membrane 314. By way of example, the membrane 314 can be formed of an acrylic material. The membrane 314 moves in response to a driving mechanism, such as the piezo transducers 122, shown in FIG. 1. The driving mechanism causes deflection in the membrane 314 that ultimately produces sound waves. In the audio/lighting system 300, light from the light panel 304 is intended to pass directly through the speaker membrane 314 without obstruction.

The diffusing membrane 310 and the speaker membrane 314 are combined into a single membrane to provide a completely integrated lighting/audio membrane. For example, the membrane 122, depicted in FIG. 1, can be configured as a single membrane that produces light and sound in accordance with the embodiments.

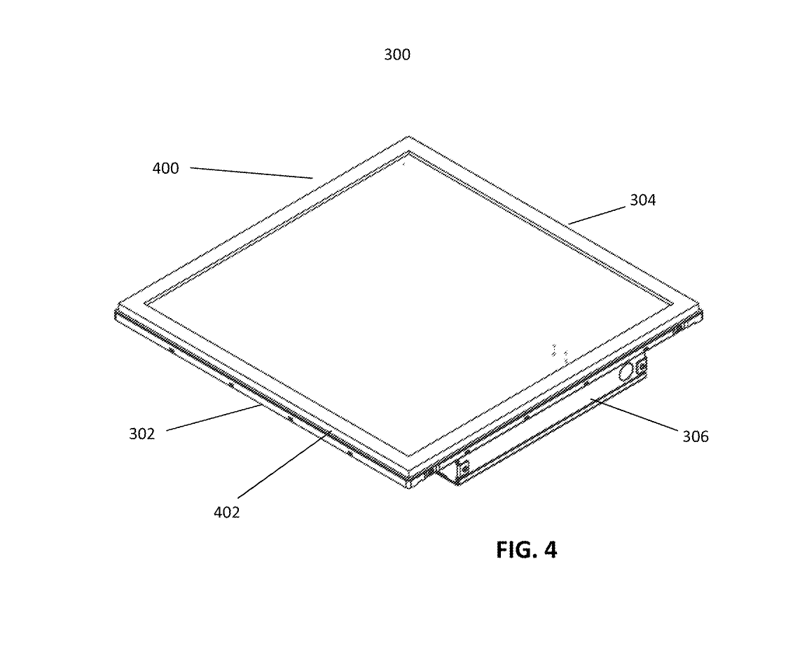

FIG. 4 is an illustration of aspects of the audio/lighting system 300 illustrated in FIG. 3, fully assembled. The depiction of the audio/lighting system 300 in FIG. 4 shows edges 400 and 402.

Although the directional lamp 100 of FIG. 1, for example, provides active cooling for LEDs, the audio/lighting system 300 does not necessarily require active cooling. That is, the audio/lighting system 300 can be adequately cooled through use of traditional passive cooling approaches, such as the use of heat sinks. For example, the symmetrical design of the audio/lighting system 300 can accommodate placement of a strip of heat sinks along the edges 400 and 402. Additionally, since the audio/lighting system 300 utilizes a diffused light source, there is little need for angular control of the light produced by the LEDs 308.

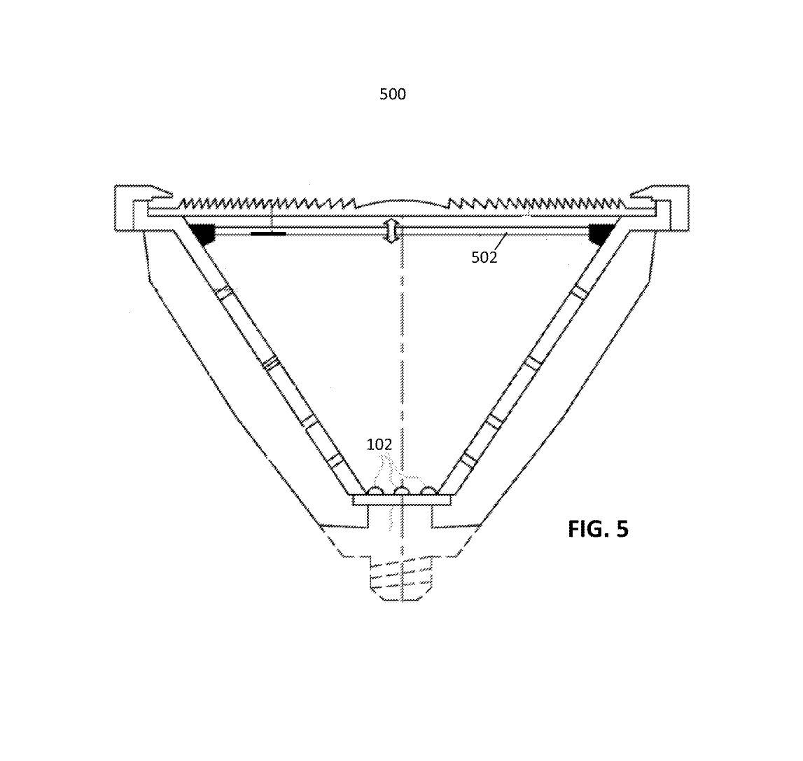

FIG. 5 is an exemplary illustration of a system 500 constructed in accordance with a second embodiment of the present invention. The system 500 includes the round conical shaped type lamp depicted in the lamp system 100 of FIG. 1. However, in the system 500, a flexible membrane (e.g., acrylic sheet) 502 functions as an optical lens and an audio speaker.

The system 500 is constructed in a manner that can benefit from active cooling due to the very close relative placement of the LEDs 102 creating a very small light source. Additionally, lighting systems, such as the system 500, are typically used in retail facilities to control, for example, light distribution over a product display console and may specify a particular beam divergence requirement. Thus, the system 500 can also benefit from light control. The act of moving the membrane 502 can change the divergence angle of the light produced by the LEDs 102 to provide light control.

For example, if a system operator desires to flex the lens 502 via the transducer 122 such that the light is to be spread out over 20°, movement or modulation of the membrane 502 will occur at a rate not perceptible to the human eye. For example, the lens 502 can be modulated in accordance with a lower frequency signal at a rate around 60 Hz to provide light control. At the same time, another signal, in a different frequency spectrum (e.g., in the kilohertz range), will be modulated to produce the sound.

As understood by one of skill in the art, although frequency is one factor in beam angle control, displacement (amplitude) is a more significant factor. Optical behavior depends on the relative positioning of objects. Generally, the more the displacement, the more the beam spreading. The frequency merely controls whether related motion is perceived as flicker.

The deflection of the membrane 502 also provides active cooling, as discussed above in relation to the system 100 of FIG. 1. In this manner, the membrane 502 functions as an optical lens, providing lighting angle and/or distribution control, an audio speaker to produce sound, and an active cooling device.

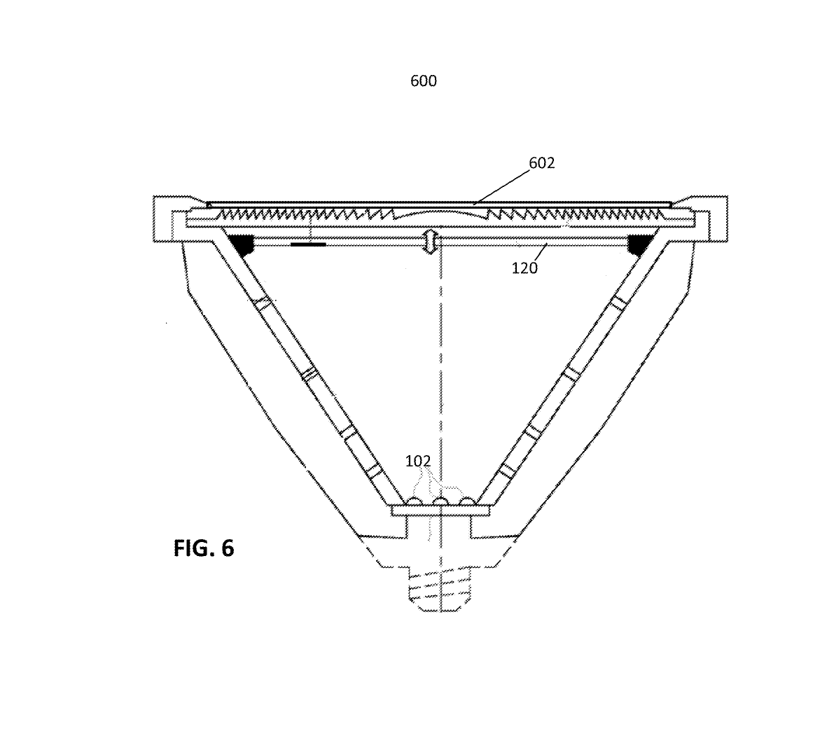

FIG. 6 is an illustration of an exemplary lighting system 600 constructed in accordance with a third embodiment of the present invention. In the system 600, a transparent overlay 602 is affixed atop the lamp system 100 to add a transparent audio speaker thereto. The transparent overlay 602 is constructed in a manner such that its placement and operation do not interfere with the optical characteristics of the lens 120.

Alternative embodiments, examples, and modifications which would still be encompassed by the disclosure may be made by those skilled in the art, particularly in light of the foregoing teachings. Further, it should be understood that the terminology used to describe the disclosure is intended to be in the nature of words of description rather than of limitation.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

We claim:

1. A light emitting diode (LED) lighting system, comprising:
one or more LEDs; and
a transparent membrane positioned in cooperative arrangement with the LEDs;
wherein the transparent membrane is configured to control light produced by the LEDs and produce sound.

2. The apparatus of claim 1, wherein the membrane is an optical membrane comprising a transparent or translucent optical diffuser.

3. The apparatus of claim 1, wherein the membrane is an optical membrane comprising a wavelength converting element including at least one phosphor compound.

4. The apparatus of claim 1, wherein the membrane is an optical membrane comprising a refractive lens.

5. The apparatus of claim 1, wherein the membrane is an optical membrane comprising a reflective surface.

6. The apparatus of claim 1, wherein the LED driver includes a circuit board and a plurality of electronic devices disposed on the circuit board, the electronic devices being selected from a group consisting of integrated circuit (IC) devices and discrete electronic devices.

7. An apparatus, comprising:
a light emitting diode (LED) lighting panel for producing light;
an enclosure enclosing the LED lighting panel, the enclosure including at least one wall defined by a membrane;
an electromechanical transducer configured to provide pulsating mechanical deformation of the membrane; and
one or more openings in the enclosure for facilitating volume displacement of air from within the enclosure, wherein the volume displacement is provided by the pulsating mechanical deformation;
wherein the deformation controls distribution of the light and produces an audio signal.

8. The apparatus of claim 7, wherein the membrane is an optical membrane comprising a transparent or translucent optical diffuser.

9. The apparatus of claim 7, wherein the membrane is an optical membrane comprising a wavelength converting element including at least one phosphor compound.

10. The apparatus of claim 7, wherein the membrane is an optical membrane comprising a refractive lens.

11. The apparatus of claim 7, wherein the membrane is an optical membrane comprising a reflective surface.

12. The apparatus of claim 7, wherein the LED driver includes a circuit board and a plurality of electronic devices disposed on the circuit board, the electronic devices being selected from a group consisting of integrated circuit (IC) devices and discrete electronic devices.

13. An apparatus, comprising:
a light emitting diode (LED) lighting panel for producing light;
an enclosure enclosing the LED lighting panel, the enclosure including two or more membranes;
one or more electromechanical transducers configured to provide pulsating mechanical deformation of the membranes; and
one or more openings in the enclosure for facilitating volume displacement of air from within the enclosure, wherein the volume displacement is provided by the pulsating mechanical deformation;
wherein the deformation of a first of the membranes controls distribution of the light; and
wherein deformation of a second of the membranes produces an audio signal.

14. The apparatus of claim 13, wherein the first membrane is an optical membrane comprising a transparent or translucent optical diffuser.

15. The apparatus of claim 13, wherein the first membrane is an optical membrane comprising a wavelength converting element including at least one phosphor compound.

16. The apparatus of claim 13, wherein the first membrane is an optical membrane comprising a refractive lens.

17. The apparatus of claim 13, wherein the first membrane is an optical membrane comprising a reflective surface.

18. The apparatus of claim 13, wherein the LED driver includes a circuit board and a plurality of electronic devices disposed on the circuit board, the electronic devices being selected from a group consisting of integrated circuit (IC) devices and discrete electronic devices.

19. The apparatus of claim 13, wherein the second membrane is optically transparent.

20. The apparatus of claim 13, wherein a first of the one or more transducers deforms the first membrane; and
wherein a second of the one or more transducers deforms the second membrane.
